(19) United States
(12) Patent Application Publication
(10) Pub. No.: US 2026/0205211 A1
(43) Pub. Date: Jul. 16, 2026

(54) COMMUNICATION APPARATUS, BASE STATION APPARATUS, AND WIRELESS COMMUNICATION SYSTEM

(71) Applicant: 1FINITY Inc., Kawasaki-shi Kanagawa (JP)

(72) Inventor: Hiroaki SENOO, Kawasaki (JP)

(73) Assignee: 1FINITY Inc., Kawasaki-shi Kanagawa (JP)

(21) Appl. No.: 19/564,895

(22) Filed: Mar. 12, 2026

Related U.S. Application Data
(63) Continuation of application No. PCT/JP2023/036402, filed on Oct. 5, 2023.

(51) Int. Cl. H04B 17/318; H04W 24/10

(52) U.S. Cl. CPC H04B 17/318; H04W 24/10

(57) ABSTRACT

A communication apparatus includes: a receiver that receives a reference signal transmitted by each of one or more base station apparatuses and measures received power corresponding to each of the reference signals; and a controller that transmits a measurement report including the received power to a first base station apparatus in a case where a total value of the received power of the reference signals is a terminal first threshold value or more.

### CROSS-REFERENCE TO RELATED APPLICATION

This application is a continuation application of International Application Number PCT/JP2023/036402 filed on Oct. 5, 2023 and designated the U.S., the entire contents of which are incorporated herein by reference.

### FIELD

The present disclosure relates to a communication apparatus, a base station apparatus, and a wireless communication system.

### BACKGROUND

For example, a terminal apparatus that is a smartphone incorporates a rechargeable battery, and needs to be periodically charged. The terminal apparatus is charged, for example, by being connected to a wired cable for supplying power and being left for a predetermined time. However, with this charging method alone, the power supply may be insufficient depending on the use frequency of the terminal apparatus. Therefore, currently, in a wireless communication system, it is considered to achieve wireless power feeding to a terminal apparatus.

The wireless power feeding is, for example, a charging method in which a current is generated by a wireless signal received by an antenna without using a wired cable, and a rechargeable battery is charged. In wireless power feeding in the wireless communication system, for example, a wireless signal is transmitted from a base station apparatus, and the terminal apparatus receives the wireless signal and performs charging by using the received wireless signal.

Techniques related to wireless power feeding are described in the following citation list.

### CITATION LIST

### Patent Literature

Patent Literature 1: JP 2019-140799 A
Patent Literature 2: JP 2023-56738 A

### SUMMARY

However, in the wireless power feeding, timing for the base station apparatus to transmit the wireless signal for the power feeding and timing for the terminal apparatus to perform power supply processing are not determined. There are cases where the terminal apparatus cannot (is unable to) efficiently perform power supply depending on the transmission timing of the wireless signal and the start timing of the power supply processing.

A communication apparatus includes, a receiver receives a reference signal transmitted by each of one or more base station apparatuses and measures received power corresponding to each of the reference signals, and a controller that transmits a measurement report including the received power to a first base station apparatus in a case where a total value of the received power of the reference signals is a terminal first threshold value or more.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a diagram illustrating an example of a configuration of a wireless communication system 10.

FIG. 2 is a diagram illustrating an example of a configuration of the base station apparatus 200.

FIG. 3 is a diagram illustrating an example of a configuration of the terminal apparatus 100.

FIG. 4 is a diagram illustrating an example of a sequence for starting the power feeding operation of the wireless power feeding processing.

FIG. 5 is a diagram illustrating an example of a processing flowchart of the measurement report control processing S200.

FIG. 6 is a diagram illustrating an example of a processing flowchart of the power feeding determination processing S300.

FIG. 7 is a diagram illustrating an example of a method of calculating the expected power feeding value.

FIG. 8 is a diagram illustrating an example of a sequence of stopping the power feeding operation of the wireless power feeding processing.

### DESCRIPTION OF EMBODIMENTS

### First Embodiment

A first embodiment will be described.

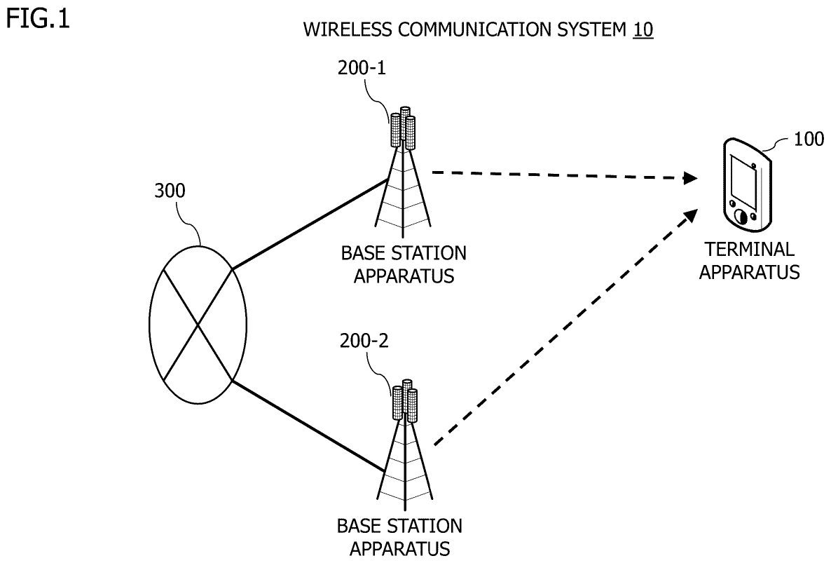

FIG. 1 is a diagram illustrating an example of a configuration of a wireless communication system 10. The wireless communication system 10 includes base station apparatuses 200-1 and 200-2, a terminal apparatus 100, and a network 300. The wireless communication system 10 is a wireless communication system that supports wireless power feeding.

The base station apparatuses 200-1 and 200-2 (hereinafter, may be referred to as base station apparatus 200) are apparatuses that are wirelessly connected to the terminal apparatus 100 and perform wireless communication, and are each an eNodeB or a gNB, for example. The base station apparatus 200 supports wireless power feeding, and supports communication generations such as 5G, New Radio (NR), or 6G, for example. In addition, the base station apparatus 200 may include one device, or may include a plurality of devices such as a central unit (CU) and a distributed unit (DU).

In addition, the base station apparatus 200 constitutes a range (for example, a cell) in which wireless communication with the terminal apparatus 100 can be performed. The base station apparatus 200-1 transmits a reference signal so that the reference signal may reach the terminal apparatus 100 in a cell (serving cell) of the apparatus (at output at which the terminal apparatus 100 is assumed to be able to receive the reference signal with predetermined power or more). The base station apparatus 200-2 transmits a reference signal so that the reference signal may reach the terminal apparatus 100 in a cell (serving cell) of the apparatus (at output at which the terminal apparatus 100 is assumed to be able to receive the reference signal with predetermined power or more). For example, each of the base station apparatuses 200-1 and 200-2 transmits the reference signal in the same frequency band (within a frequency band of a predetermined width).

The terminal apparatus 100 is a communication apparatus that is wirelessly connected to the base station apparatus 200 and transmits and receives data, and is, for example, a smartphone or a tablet terminal. The terminal apparatus 100 supports wireless power feeding.

The network 300 is a network that connects between the base station apparatuses 200, and includes, for example, the Internet, a core network controller (for example, Evolved Packet Core (EPC)), or the like. The base station apparatuses 200-1 and 200-2 communicate with each other via the network 300.

The base station apparatus 200 transmits a reference signal. The terminal apparatus 100 receives the reference signal and measures received power. The reference signal measured by the terminal apparatus 100 includes, for example, a reference signal transmitted by the base station apparatus 200 in communication and a reference signal transmitted by a neighboring base station apparatus 200. Using a total value of the received power of the reference signals, the terminal apparatus 100 determines whether to transmit a measurement report. Using the received power of the measurement report, the base station apparatus 200 determines the start or stop of the wireless power feeding.

### Example of Configuration of Base Station Apparatus 200

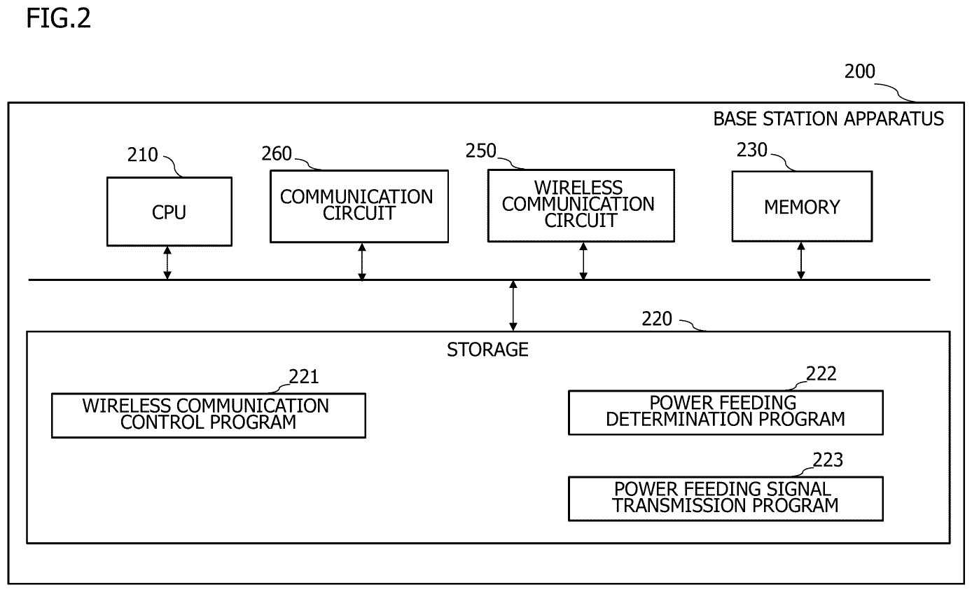

FIG. 2 is a diagram illustrating an example of a configuration of the base station apparatus 200. The base station apparatus 200 includes a central processing unit (CPU) 210, a storage 220, a memory 230, a wireless communication circuit 250, and a communication circuit 260.

The storage 220 is an auxiliary storage device such as a flash memory, a hard disk drive (HDD), or a solid state drive (SSD) that stores programs and data. The storage 220 stores a wireless communication control program 221, a power feeding determination program 222, and a power feeding signal transmission program 223.

The memory 230 is an area into which the programs stored in the storage 220 are loaded. In addition, the memory 230 may also be used as an area where a program stores data.

The wireless communication circuit 250 is an apparatus that performs wireless communication with the terminal apparatus 100. The base station apparatus 200 transmits and receives signals (messages) to and from the terminal apparatus 100 via the wireless communication circuit 250. Note that the wireless communication circuit 250 may be used to transmit a power feeding signal (signal used by the terminal apparatus 100 for wireless power feeding). In addition, the power feeding signal may be transmitted by a circuit (not illustrated) that is capable of transmitting a wireless signal, the circuit being other than the wireless communication circuit 250.

The CPU 210 is a processor that loads the program stored in the storage 220 into the memory 230, executes the loaded program, builds each unit, and achieves respective processing.

The CPU 210 executes the wireless communication control program 221 to build a base station control unit and a transmission unit and perform wireless communication control processing. The wireless communication control processing is processing of wirelessly connecting to the terminal apparatus 100 and transmitting and receiving signals via the established wireless connection. The base station apparatus 200 controls wireless communication in the wireless communication control processing.

The CPU 210 executes the power feeding determination program 222 to build a base station control unit and a transmission unit and perform power feeding determination processing. The power feeding determination processing is, for example, processing executed when the measurement report is received from the terminal apparatus 100, and is processing of determining whether to start power feeding on the basis of a measurement result of the terminal apparatus 100. When determining to start power feeding, the base station apparatus 200 thereafter transmits a power feeding signal, for example, at a predetermined time.

The CPU 210 executes the power feeding signal transmission program 223 to build a base station control unit and a transmission unit, and performs power feeding signal transmission processing. The power feeding signal transmission processing is, for example, processing of transmitting a power feeding signal to the terminal apparatus 100 at a predetermined time after it is determined to start power feeding.

### Example of Configuration of Terminal Apparatus 100

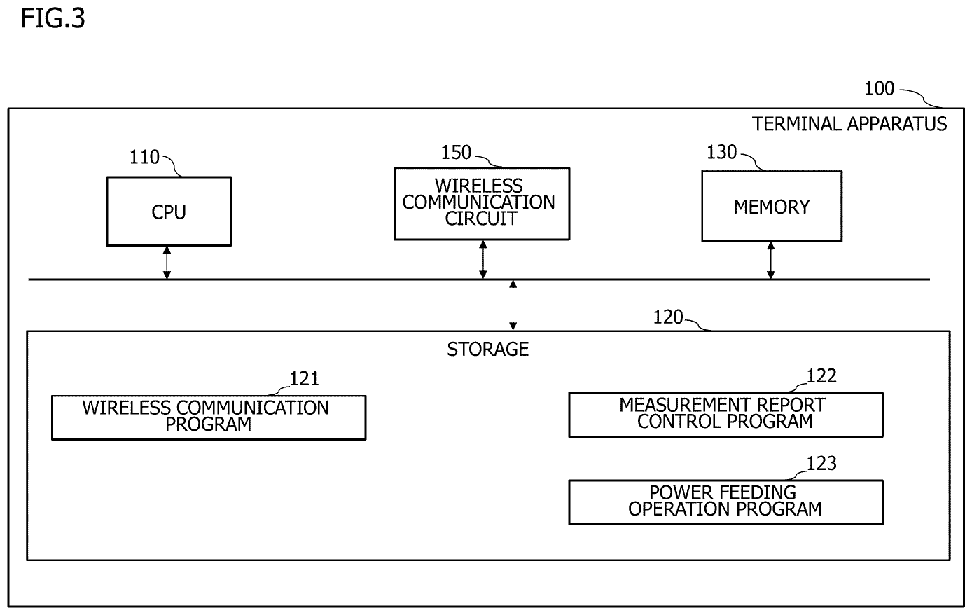

FIG. 3 is a diagram illustrating an example of a configuration of the terminal apparatus 100. The terminal apparatus 100 includes a CPU 110, a storage 120, a memory 130, and a wireless communication circuit 150.

The storage 120 is an auxiliary storage device such as a flash memory, an HDD, or an SSD that stores programs and data. The storage 120 stores a wireless communication program 121, a measurement report control program 122, and a power feeding operation program 123.

The memory 130 is an area into which the programs stored in the storage 120 are loaded. In addition, the memory 130 may also be used as an area where the programs store data.

The wireless communication circuit 150 is a device that performs wireless communication with the base station apparatus 200. The terminal apparatus 100 transmits and receives signals to and from the base station apparatus 200 via the wireless communication circuit 150. Note that the wireless communication circuit 150 may, for example, receive a power feeding signal and perform processing related to power feeding. In addition, the power feeding signal may be received using, for example, a communication circuit (not illustrated) having an antenna, a rectifier circuit, or the like that receives the power feeding signal, the communication circuit being other than the wireless communication circuit 150.

The CPU 110 is a processor that loads a program stored in the storage 120 into the memory 130, executes the loaded program, builds each unit, and achieves each processing.

The CPU 110 executes the wireless communication program 121 to build a control unit and a reception unit and perform wireless communication processing. The wireless communication processing is processing of wirelessly connecting to the base station apparatus 200 and performing communication therewith.

The CPU 110 executes the measurement report control program 122 to build a control unit and a reception unit and perform measurement report control processing. The measurement report control processing is processing of receiving reference signals transmitted by the base station apparatus 200 in communication (cell within range) and a neighboring base station apparatus 200, measuring received power, and controlling whether to transmit a measurement report according to the received power.

### Wireless Power Feeding Processing

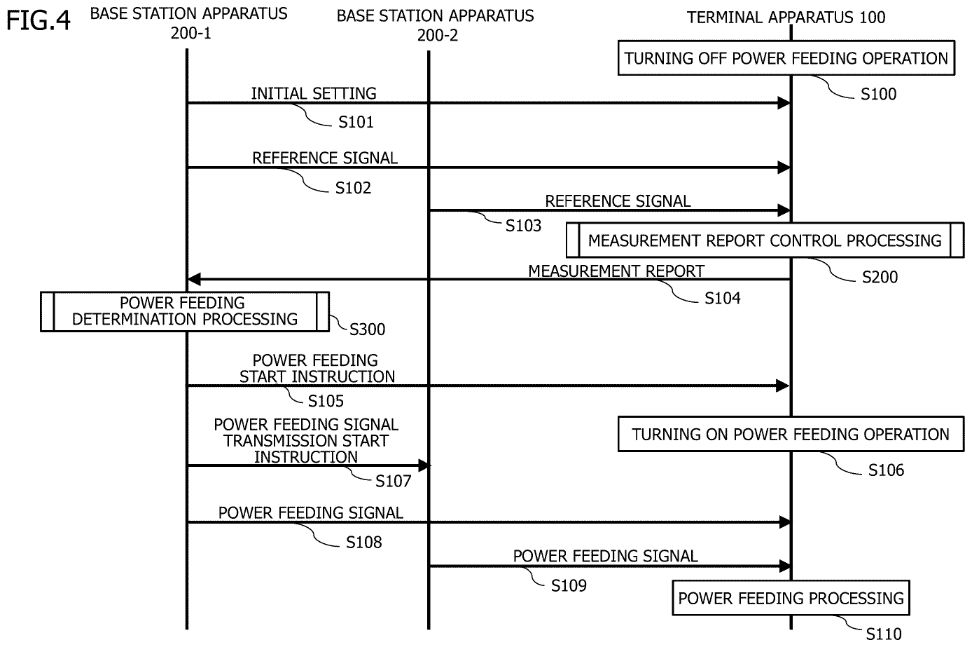

The wireless power feeding processing will be described. FIG. 4 is a diagram illustrating an example of a sequence for starting the power feeding operation of the wireless power feeding processing. Note that for the terminal apparatus 100, the base station apparatus 200-1 is associated with a PCell (serving cell) and the base station apparatus 200-2 is a neighboring base station apparatus that constitutes a neighbor cell. Note that in FIG. 4, although there is one neighboring base station apparatus, there may be a plurality of neighboring base station apparatuses.

For example, the terminal apparatus 100 sets the power feeding operation to OFF in an initial state (S100).

The base station apparatus 200 transmits an initial setting to the terminal apparatus 100 (S101). The initial setting includes power feeding information related to the power feeding. The power feeding information includes, for example, a terminal first threshold value, a terminal second threshold value, and radio resources (frequency band, transmission timing, and the like) of a reference signal to be described below. The initial setting is transmitted using, for example, broadcast information such as SIB or an RRC message.

The terminal apparatus 100 receives a reference signal according to the power feeding information (S102, S103). For example, there are cases where the terminal apparatus 100 determines, as a neighboring base station apparatus, the base station apparatus 200 that is the source of the transmitted reference signal that has been received with predetermined power or more within a predetermined period and the terminal apparatus 100 includes, in a Measurement report, measurement results of reference signals of the base station apparatus 200 (PCell) in the serving cell and the neighboring base station apparatus 200.

When receiving, for example, reference signals transmitted within the same frequency band from the base station apparatus 200 in the serving cell and the neighboring base station apparatus 200, the terminal apparatus 100 performs the measurement report control processing (S200).

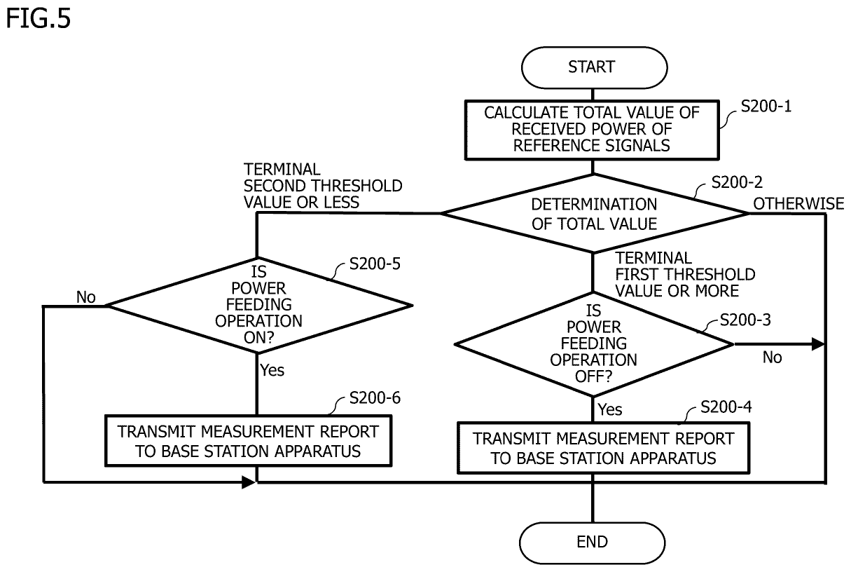

FIG. 5 is a diagram illustrating an example of a processing flowchart of the measurement report control processing S200. The terminal apparatus 100 calculates a total value of the received power of the reference signals (S200-1).

The terminal apparatus 100 compares the calculated total value with the terminal first threshold value and the terminal second threshold value (S200-2).

In a case where the total value is the terminal first threshold value or more (“terminal first threshold value or more” in S200-2), the terminal apparatus 100 checks the power feeding operation (state related to the power feeding operation of the apparatus) (S200-3). In a case where the power feeding operation is on (No in S200-3), the terminal apparatus 100 does not transmit a measurement report and ends the processing. On the other hand, in a case where the power feeding operation is off (Yes in S200-3), the terminal apparatus 100 transmits a measurement report including the received power of the reference signal to the base station apparatus in the serving cell (S200-4) and ends the processing.

In a case where the total value is the terminal second threshold value or less (“terminal second threshold value or less” in S200-2), the terminal apparatus 100 checks the power feeding operation (S200-5). In a case where the power feeding operation is OFF (No in S200-5), the terminal apparatus 100 ends the processing without transmitting a measurement report. On the other hand, in a case where the power feeding operation is ON (Yes in S200-5), the terminal apparatus 100 transmits a measurement report including the received power of the reference signal to the base station apparatus in the serving cell (S200-6) and ends the processing.

In a case where the total value is less than the terminal first threshold value and greater than the terminal second threshold value (“otherwise” in S200-2), the terminal apparatus 100 does not transmit a measurement report and ends the processing.

Note that the measurement report may be, for example, a Measurement report or other messages. In addition, the measurement report may be transmitted by, for example, using an RRC message, an MAC CE, CSI, or the like.

As described above, the terminal apparatus 100 transmits the measurement report to the base station apparatus 200 as a trigger for turning on or off the power feeding operation. The base station apparatus 200 determines on or off of the power feeding operation according to the received power of the reference signal included in the measurement report.

Returning to the sequence of FIG. 4, in the measurement report control processing S200, the terminal apparatus 100 calculates a total value of the received power of the reference signal S102 and the reference signal S103 (S200-1 of FIG. 5), determines that the total value is the terminal first threshold value or more (“terminal first threshold value or more” in S200-2 of FIG. 5), and transmits the measurement report to the base station apparatus 200-1 because the power feeding operation is off (Yes in S200-3 of FIG. 5) (S104, S200-4 of FIG. 5).

When receiving the measurement report (S104), the base station apparatus 200 performs power feeding determination processing (S300).

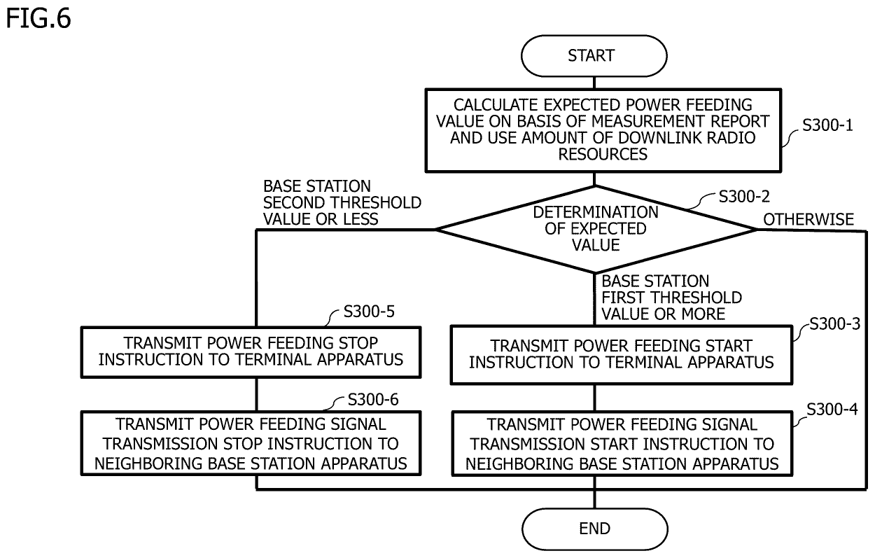

FIG. 6 is a diagram illustrating an example of a processing flowchart of the power feeding determination processing S300. The base station apparatus 200 calculates an expected power feeding value on the basis of the received power of the reference signal included in the measurement report and a use amount of the radio resource (S300-1).

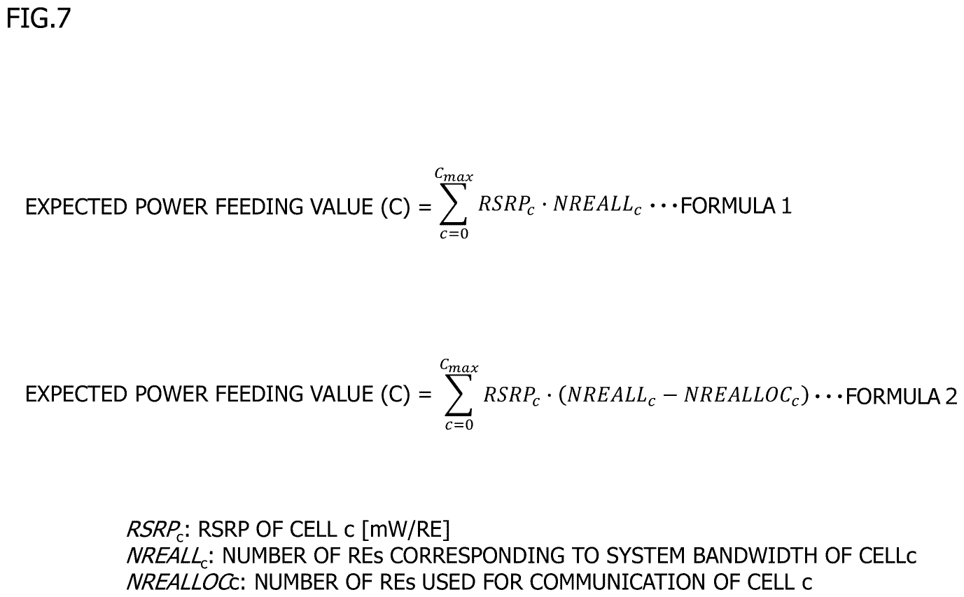

FIG. 7 is a diagram illustrating an example of a method of calculating the expected power feeding value. Formula 1 is a formula used in a case where a charging effect in the terminal apparatus 100, the charging effect including the radio resources used for communication, is used as a determination reference. The expected power feeding value of Formula 1 is a power value (for example, a value based on a theoretical value or an actual measurement value) predicted to be generated in the terminal apparatus 100 when the power feeding processing is performed in response to both the power feeding signal and a signal used for communication. Formula 1 is a formula for calculating the expected power feeding value using the received power (RSRP) of the reference signal of each cell and the number of resource elements (REs) corresponding to a system bandwidth of the cell.

Formula 2 is a formula used when an effect of transmitting the power feeding signal from the base station apparatus 200 is used as a determination reference. The expected power feeding value of Formula 2 is a power value predicted to increase in the terminal apparatus 100 when the power feeding processing is performed in response to both the power feeding signal and the signal used for communication (power value that increases from when the power feeding processing is performed in response only to the signal used for communication). In addition, the expected power feeding value of Formula 2 is a power value predicted to be generated in the terminal apparatus 100 when the power feeding processing is performed in response only to the power feeding signal. In Formula 2, the expected power feeding value is calculated using the RSRP of the reference signal of each cell and the number of REs obtained by subtracting the number of REs used for communication of the cell from the number of REs corresponding to a system bandwidth of the cell.

Returning to the processing flowchart of FIG. 6, in the power feeding determination processing S300, the base station apparatus 200 compares the calculated expected power feeding value with a base station first threshold value and a base station second threshold value (S300-2).

In a case where the expected power feeding value is the base station first threshold value or more (“base station first threshold value or more” in S300-2), the base station apparatus 200 transmits a power feeding start instruction, which is a message instructing to turn on the power feeding operation, to the terminal apparatus 100 (S300-3), transmits a power feeding signal transmission start instruction, which is a message instructing to start transmission of the power feeding signal, to the neighboring base station apparatus 200 (S300-4), and ends the processing.

In a case where the expected power feeding value is the base station second threshold value or less (“base station second threshold value or less” in S300-2), the base station apparatus 200 transmits a power feeding stop instruction, which is a message instructing to turn off the power feeding operation, to the terminal apparatus 100 (S300-5), transmits a power feeding signal transmission stop instruction, which is a message instructing to stop transmission of the power feeding signal, to the neighboring base station apparatus 200 (S300-6), and ends the processing.

In a case where the expected power feeding value is less than the base station first threshold value and greater than the base station second threshold value (“otherwise” in S300-2), the base station apparatus 200 does not transmit an instruction and ends the processing.

Returning to the sequence of FIG. 4, in the power feeding determination processing S300, the base station apparatus 200 calculates the expected power feeding value (S300-1 of FIG. 6), determines that the expected power feeding value is the base station first threshold value or more (“base station first threshold value or more” in S300-2 of FIG. 6), and transmits a power feeding start instruction to the terminal apparatus 100 (S105, S300-3 of FIG. 6).

In addition, in the power feeding determination processing S300, the base station apparatus 200 transmits a power feeding signal transmission start instruction to the base station apparatus 200-2 (S107, S300-4 of FIG. 6).

When receiving the power feeding start instruction (S105), the terminal apparatus 100 turns on the power feeding operation (S106).

The base station apparatus 200-1 and the base station apparatus 200-2 that has received the power feeding transmission start instruction each start transmission of a power feeding signal, and transmit the power feeding signal, for example, at a predetermined time (S108, S109).

When receiving the power feeding signal in a state where the power feeding operation is on (S108, S109), the terminal apparatus 100 performs the power feeding processing (S110) and charges a battery of the apparatus.

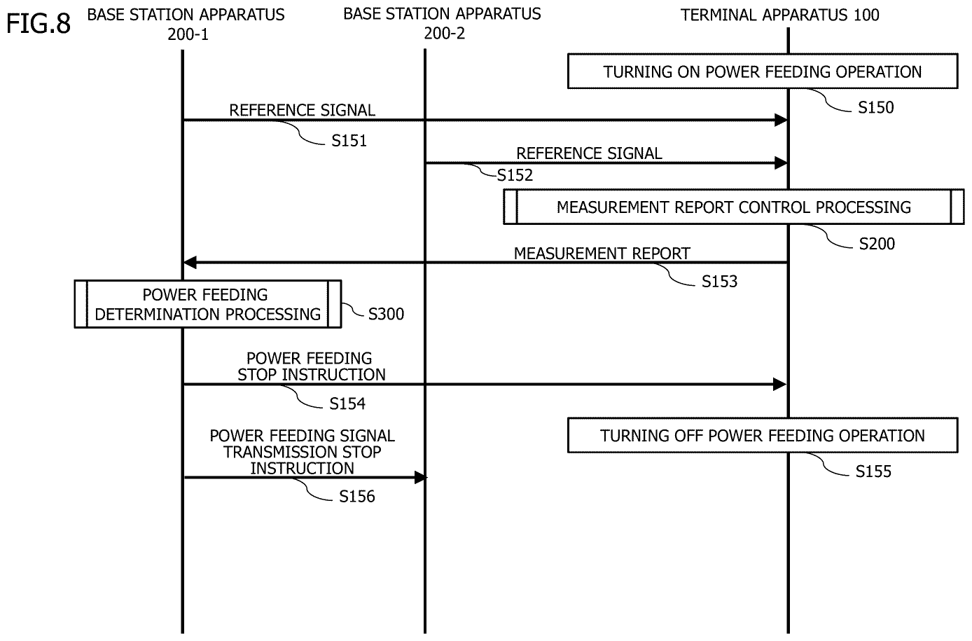

FIG. 8 is a diagram illustrating an example of a sequence of stopping the power feeding operation of the wireless power feeding processing. It is assumed that the terminal apparatus 100 is in an on state of the power feeding operation.

The terminal apparatus 100 receives a reference signal according to the power feeding information (S151, S152).

When receiving the reference signals of the base station apparatus 200 and the neighboring base station apparatus 200 in the serving cell, the terminal apparatus 100 performs the measurement report control processing (S200).

In the measurement report control processing S200, the terminal apparatus 100 calculates a total value of the received power of the reference signal S151 and the reference signal S152 (S200-1 of FIG. 5), determines that the total value is the terminal second threshold value or less (“terminal second threshold value or less” in S200-2 of FIG. 5), and transmits a measurement report to the base station apparatus 200-1 (S153, S200-6 of FIG. 5) because the power feeding operation is ON (Yes in S200-5 of FIG. 5).

When receiving the measurement report (S153), the base station apparatus 200 performs the power feeding determination processing (S300).

In the power feeding determination processing S300, the base station apparatus 200 calculates the expected power feeding value (S300-1 of FIG. 6), determines that the expected power feeding value is the base station second threshold value or less (“base station second threshold value or less” in S300-2 of FIG. 6), and transmits a power feeding stop instruction to the terminal apparatus 100 (S154, S300-5 of FIG. 6).

In addition, in the power feeding determination processing S300, the base station apparatus 200 transmits a power feeding signal transmission stop instruction to the base station apparatus 200-2 (S156, S300-6 of FIG. 6).

When receiving the power feeding stop instruction, the terminal apparatus 100 sets the power feeding operation to OFF (S155).

The base station apparatus 200-1 and the base station apparatus 200-2 that has received the power feeding transmission stop instruction stop transmission of the power feeding signal.

Note that in the sequence (FIG. 4) described above, the total value of the received power in the terminal apparatus 100 is the terminal first threshold value or more, and the expected power feeding value in the base station apparatus 200 is the base station first threshold value or more. However, there are cases where even if the total value of the received power in the terminal apparatus 100 is the terminal first threshold value or more, the expected power feeding value in the base station apparatus 200 is not the base station first threshold value or more. In addition, in the sequence diagram 8 described above, the total value of the received power in the terminal apparatus 100 is the terminal second threshold value or less, and the expected power feeding value in the base station apparatus 200 is the base station second threshold value or less. However, there are cases where even if the total value of the received power in the terminal apparatus 100 is the terminal second threshold value or less, the expected power feeding value in the base station apparatus 200 is not the base station second threshold value or less.

In addition, the terminal first threshold value, the terminal second threshold value, the base station first threshold value, and the base station second threshold value may be determined according to, for example, a charging efficiency of the terminal apparatus 100 or the like. The charging efficiency is a ratio of feeding power to the received power of the wireless signal, and for example, the charging efficiency is obtained by Y/X in a case where the feeding power of Y [mW] is obtained when the wireless signal of X [mW] is received.

### On/Off of Power Feeding Operation

As described above, the terminal apparatus 100 has a state in which the power feeding operation is ON and a state in which the power feeding operation is OFF.

The state in which the power feeding operation is ON is, for example, a state in which the terminal apparatus 100 receives the power feeding signal and performs the power feeding processing. In a case where the power feeding operation is ON, the terminal apparatus 100 stops processing related to data reception, such as PDCCH reception processing, but performs reception processing necessary (key) for the measurement report, such as reception of a reference signal.

The state in which the power feeding operation is OFF is, for example, a state in which the terminal apparatus 100 does not receive the power feeding signal (or even if the terminal apparatus 100 receives the power feeding signal) and does not perform the power feeding processing (it is possible to perform the power feeding processing in response to a signal other than the power feeding signal). In a case where the power feeding operation is OFF, the terminal apparatus 100 starts (resumes) the stopped PDCCH reception processing, for example.

### Other Embodiments

The communication state of the terminal apparatus 100, for example, may be considered for a determination of switching between ON and OFF of the power feeding operation. For example, the determination in processing S200-3 of FIG. 5 may be replaced with “the apparatus is not communicating with another communication apparatus and power feeding operation is OFF”. In other words, in a case where the apparatus 100 is in communication, the terminal apparatus 100 may perform operation of not starting the power feeding operation. Note that for example, in a case where buffer retention amounts on the upstream side and the downstream side are zero, the terminal apparatus 100 may determine that the apparatus is not in communication.

Similarly, the base station apparatus 200 may determine whether to transmit the power feeding start instruction in consideration of the communication state of the terminal apparatus 100.

In addition, in the embodiment described above, each of “or more”, “or less”, “less than”, and “greater than” may be replaced with “greater than”, “less than”, “or less”, and “or more”, respectively.

According to one disclosure, wireless power feeding processing can be performed at an appropriate time.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that the various changes, substitutions, and alterations could be made hereto without departing from the spirit and scope of the disclosure.

What is claimed is;

1. A communication apparatus comprising:
a receiver that receives a reference signal transmitted by each of one or more base station apparatuses and measures received power corresponding to each of the reference signals; and
a controller that transmits a measurement report including the received power to a first base station apparatus in a case where a total value of the received power of the reference signals is a terminal first threshold value or more.

2. The communication apparatus according to claim 1, wherein
when receiving the measurement report, the first base station apparatus transmits a power feeding start instruction to instruct the communication apparatus to start power feeding in a case where an expected power feeding value of the communication apparatus is a base station first threshold value or more.

3. The communication apparatus according to claim 2, wherein
when receiving the power feeding start instruction, the controller receives a power feeding signal transmitted from the one or more base station apparatuses to generate power, and starts power feeding processing of charging a rechargeable battery of the communication apparatus with the generated power.

4. The communication apparatus according to claim 1, wherein
the controller transmits the measurement report when the total value is a terminal second threshold value or less.

5. The communication apparatus according to claim 4, wherein
when receiving the measurement report, the first base station apparatus transmits a power feeding stop instruction to instruct the communication apparatus to stop power feeding in a case where an expected power feeding value of the communication apparatus is a base station second threshold value or less.

6. The communication apparatus according to claim 3, wherein
the expected power feeding value is a value corresponding to an amount of power generated when the communication apparatus receives the power feeding signal.

7. The communication apparatus according to claim 3, wherein
the expected power feeding value is a value corresponding to an amount of power generated when the power feeding signal and a signal used for communication are received.

8. A base station apparatus comprising:
a transmitter that transmits a reference signal;
a receiver that receives a measurement report including received power of the reference signal from a communication apparatus, the measurement report including the base station apparatus and other base station apparatus ; and
a base station controller that transmits a power feeding start instruction to instruct the communication apparatus to start power feeding in a case where the expected power feeding value of the communication apparatus is a base station first threshold value or more when the measurement report is received.

9. The base station apparatus according to claim 8, wherein
when transmitting the power feeding start instruction, the base station controller transmits a power feeding signal transmission instruction to instruct transmission of a power feeding signal to another base station apparatus included in the measurement report, and starts transmission of the power feeding signal to the communication apparatus.

10. A wireless communication system comprising:
one or more base station apparatuses and a communication apparatus, wherein
each of the one or more base station apparatuses transmits a reference signal,
the communication apparatus measures received power of the reference signal, and transmits a measurement report including the received power to a first base station apparatus in a case where a total value of the received power of each of the reference signals is a terminal first threshold value or more, and
when receiving the measurement report, the first base station apparatus transmits a power feeding start instruction to instruct the communication apparatus to start power feeding in a case where an expected power feeding value of the communication apparatus is a base station first threshold value or more.
